(19) United States
(12) Patent Application Publication
(10) Pub. No.: US 2024/0383072 A1
(43) Pub. Date: Nov. 21, 2024

(54) COMPUTER-IMPLEMENTED MONITORING OF A WELDING OPERATION

(71) Applicant: AutoMetrics Manufacturing Technologies Inc., Vancouver (CA)

(72) Inventor: Seyyed Mohammad MOHSENI, North York (CA)

(21) Appl. No.: 18/687,051

(22) PCT Filed: Dec. 24, 2021
(86) PCT No.: PCT/CA2021/051889

§ 371 Date: Feb. 27, 2024

Related U.S. Application Data
(60) Provisional application No. 63/240,804, filed on Sep. 3, 2021.

(51) Int. Cl. B23K 26/20; B23K 31/12

(52) U.S. Cl. CPC B23K 26/20; B23K 31/125

(57) ABSTRACT

A computer-implemented method of monitoring a quality of a welding operation. The method includes: obtaining video of the welding operation in progress; processing the video to identify regions of interest in the video, each region of interest corresponding to a portion of an image in the video; for each region of interest, determining a quality index by processing the portion of the image corresponding to the region of interest; and based on the quality indices determined for the regions of interest, generating one or more welding quality signals indicative of the quality of the welding operation.

### FIELD

The present disclosure relates to the monitoring of a welding operation, and in particular to methods, systems, and computer-readable media configured for performing real-time monitoring of a quality of a welding operation.

### BACKGROUND

Welding has widespread use in the manufacturing industry, from the automotive and construction sectors to shipbuilding and pipelines. Weld quality determines the overall performance of structural parts and should adhere to specific quality standards. Companies regularly practice due diligence during welding operation planning and execution in order to avoid welding defects, since alternatives would include costly reworks to fix defective parts, or worse still complete rejection of a poorly welded component.

Despite advances in automation, welding quality inspection remains primarily manual, and is focused on identifying weld defects after production. There is a high level of risk associated with this practice in part due to the identification of potential defects at such a late stage of the production cycle. The associated downtime and financial cost of reworks can add up to two or three times the original predicted project cost. The lack of a reliable and scalable technology is the main deterrent to real-time welding inspection.

In contrast to real-time quality monitoring, conducting inspection after production generally occurs in series with other production operations, increasing lead time and costs. This is even more notable in mission-critical parts that require inspection and validation from multiple independent parties. Consequently, in high-count manufacturing lines, inspection is generally only conducted for a specific number of random samples, leading to an increased probability of defective parts escaping the manufacturing line.

Currently, real-time inspection relies on manual observation by expert welders. This involves high labor costs and safety risks, e.g. working in proximity to robots, and is not scalable in high-count production lines. The use of remote monitoring systems such as welding cameras has enhanced safety and data recording, but the issue of human dependency and its associated costs and errors still lingers.

Laser and X-ray systems are more sophisticated means for quality inspection, and may reveal defects in the weld after production. However, these solutions do not eliminate the risk and costs of late-stage defect discovery, and such systems are often complex to operate and require laborious calibrations with any changeover.

### SUMMARY

According to a first aspect of the disclosure, there is provided a computer-implemented method of monitoring a quality of a welding operation, the method comprising: obtaining video of the welding operation in progress; processing the video to identify regions of interest in the video, each region of interest corresponding to a portion of an image in the video; for each region of interest, determining a quality index by processing the portion of the image corresponding to the region of interest; based on the quality indices determined for the regions of interest, generating one or more welding quality signals indicative of the quality of the welding operation; determining, based on the one or more welding quality signals, that the welding operation is not progressing normally; in response to determining that the welding operation is not progressing normally, comparing the one or more welding quality signals to one or more stored welding quality signals, wherein each stored welding quality signal is associated with a respective source of a deviation of the stored welding quality signal from one or more normal welding quality signals associated with one or more welding operations that progressed normally; and identifying, based on the comparison, a source of the deviation of the one or more welding quality signals from the one or more normal welding quality signals.

The method may further comprise, based on the identification of the source of the deviation of the one or more welding quality signals, adjusting one or more parameters of the welding operation so as adjust a progression of the welding operation.

Obtaining the video may comprise capturing, using one or more cameras, images of the welding operation in progress.

Processing the video to identify the regions of interest may comprise: extracting one or more features from images in the video; comparing the extracted one or more features to one or more stored features, wherein the one or more stored features are extracted from images obtained from one or more other welding operations and comprising the regions of interest; and identifying, based on the comparison, the regions of interest in the video of the welding operation.

The method may further comprise, during a training phase prior to the welding operation: obtaining video of each of multiple training welding operations; for each training welding operation, processing the video of the training welding operation to identify training regions of interest in the video, each training region of interest corresponding to a portion of an image in the video of the training welding operation; and for each training region of interest, determining a quality index based on a quality of the training welding operation associated with the training region of interest.

Determining the quality index may comprise: comparing the processed portion of the image corresponding to the region of interest to one or more processed portions of the images corresponding to the training regions of interest; and based on the comparison and based on one or more quality indices determined for the training regions of interest, determining the quality index for the region of interest.

During at least one of the training welding operations, a process deviation may be introduced into the at least one of the training welding operations.

The process deviation may comprise one or more of: a current or voltage interruption; a wire feed interruption; a protective gas flow interruption; burn-through; oil, grease, moisture, dust, oxidation, or rust on the surface of the weld; and a welding arc or laser interruption.

Processing the video to identify the regions of interest may comprise: inputting the video to a trained neural network; and identifying the regions of interest using the trained neural network.

Determining the quality index may comprise: processing the portion of the image corresponding to the region of interest; comparing the processed portion of the image corresponding to the region of interest to a stored processed portion of an image, wherein the stored processed portion of the image corresponds to a region of interest identified in video of one or more other welding operations; and based on the comparison, determining the quality index for the region of interest.

Processing the portion of the image corresponding to the region of interest may comprise converting the portion of the image corresponding to the region of interest to a first matrix representing the region of interest. Comparing the processed portion of the image to the stored processed portion of the image may comprise comparing the first matrix to a second matrix representing the region of interest corresponding to the stored processed portion of the image.

Determining the quality index may comprise: identifying one or more similarities between the first matrix and the second matrix; and determining the quality index based on the one or more similarities.

The regions of interest may comprise one or more of: a melt spatter region corresponding to a portion in each of one or more images in the video, wherein the portion shows melt spatter occurring during the welding operation; a welding arc or laser region corresponding to a portion in each of one or more images in the video, wherein the portion shows a welding arc or laser produced during the welding operation; a melt pool region corresponding to a portion in each of one or more images in the video, wherein the portion shows a melt pool formed during the welding operation; and a weld seam region corresponding to a portion in each of one or more images in the video, wherein the portion shows a weld seam formed during the welding operation.

The regions of interest may consist of one or more of: the melt spatter region; the welding arc or laser region; the melt pool region; and the weld seam region.

The method may further comprise, during the welding operation: obtaining welding process data associated with the welding operation; and determining one or more process quality indices for the welding process data. Generating the one or more welding quality signals may be further based on the one or more process quality indices.

Determining the one or more process quality indices may comprise: comparing the welding process data to stored welding process data, wherein the stored welding process data is associated with one or more other welding operations; and based on the comparison, determining the one or more process quality indices.

The method may further comprise, during a training phase prior to the welding operation: obtaining sets of welding process data associated with multiple training welding operations; and for each set of welding process data associated with a given one of the training welding operations, determining a process quality index based on a quality of the training welding operation associated with the welding process data.

Determining the one or more process quality indices may comprise: comparing the welding process data associated with the welding operation to the welding process data associated with the training welding operations; and based on the comparison and based on the one or more process quality indices determined for the welding process data associated with the training welding operations, determining the one or more welding process quality indices for the welding process data associated with the welding operation.

The welding process data may comprise data relating to one or more of: audio captured during the welding operation using one or more audio sensors; a colour of a welding arc or laser produced during the welding operation; heat emitted or dissipated during the welding operation; a current used for producing a welding arc or laser during the welding operation; and a voltage used for producing a welding arc or laser during the welding operation.

Determining that the welding operation is not progressing normally may comprise: comparing the one or more welding quality signals to one or more thresholds; and determining, based on the comparison, that the welding operation is not progressing normally.

The method may further comprise, during a training phase prior to the welding operation, generating the one or more stored welding quality signals by: obtaining video of each of one or more training welding operations, wherein at least one of the one or more training welding operations did not progress normally; for each training welding operation, processing the video of the training welding operation to identify training regions of interest in the video, each training region of interest corresponding to a portion of an image in the video of the training welding operation; for each training region of interest, determining a quality index based on a quality of the training welding operation associated with the training region of interest; based on the quality indices determined for the training regions of interest, generating, for each of the training welding operations, one or more welding quality signals; and storing the generated one or more welding quality signals to thereby form the one or more stored welding quality signals.

Generating the one or more welding quality signals may comprise generating one or more strings of numbers. Each number may be based on the quality index determined for one of the regions of interest.

Generating the one or more welding quality signals may comprise generating one or more strings of numbers. Each number may be based on one of the process quality indices determined for the welding process data.

According to a further aspect of the disclosure, there is provided a system for monitoring a quality of a welding operation, comprising: a welding device for performing a welding operation;

one or more cameras positioned so as to capture video of the welding operation when in progress; and one or more processors communicative with the one or more cameras and configured, during the welding operation, to: obtain, from the one or more cameras, video of the welding operation in progress; process the video to identify regions of interest in the video, each region of interest corresponding to a portion of an image in the video; for each region of interest, determine a quality index by processing the portion of the image corresponding to the region of interest; based on the quality indices determined for the regions of interest, generate one or more welding quality signals indicative of the quality of the welding operation; determine, based on the one or more welding quality signals, that the welding operation is not progressing normally; in response to determining that the welding operation is not progressing normally, compare the one or more welding quality signals to one or more stored welding quality signals, wherein each stored welding quality signal is associated with a respective source of a deviation of the stored welding quality signal from one or more normal welding quality signals associated with one or more welding operations that progressed normally; and identify, based on the comparison, a source of the deviation of the one or more welding quality signals from the one or more normal welding quality signals.

According to a further aspect of the disclosure, there is provided a computer-readable medium having stored thereon computer program code configured, when executed by one or more processors, to perform a method comprising: obtaining video of a welding operation in progress; processing the video to identify regions of interest in the video, each region of interest corresponding to a portion of an image in the video; for each region of interest, determining a quality index by processing the portion of the image corresponding to the region of interest; based on the quality indices determined for the regions of interest, generating one or more welding quality signals indicative of the quality of the welding operation; determining, based on the one or more welding quality signals, that the welding operation is not progressing normally; in response to determining that the welding operation is not progressing normally, comparing the one or more welding quality signals to one or more stored welding quality signals, wherein each stored welding quality signal is associated with a respective source of a deviation of the stored welding quality signal from one or more normal welding quality signals associated with one or more welding operations that progressed normally; and identifying, based on the comparison, a source of the deviation of the one or more welding quality signals from the one or more normal welding quality signals.

According to a further aspect of the disclosure, there is provided a computer-implemented method of monitoring a quality of a welding operation creating a weld, the method comprising: obtaining video of the welding operation in progress; processing the video to identify regions of interest in the video, each region of interest corresponding to a portion of an image in the video, wherein the portion of the image does not include the weld; for each region of interest, determining a quality index by processing the portion of the image corresponding to the region of interest; based on the quality indices determined for the regions of interest, generating one or more welding quality signals indicative of the quality of the welding operation. This aspect of the disclosure may include any of the features described above in connection with the first aspect of the disclosure.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1 is a schematic diagram of a welding device for use with a system configured to perform real-time inspection of a quality of a welding operation, according to an embodiment of the disclosure;

FIG. 2 is a schematic diagram of hardware components of a welding system configured to perform real-time inspection of a quality of a welding operation, according to an embodiment of the disclosure;

FIG. 3 is a flow diagram of a method of training a welding system for performing real-time inspection of a quality of a welding operation, according to an embodiment of the disclosure;

FIGS. 4A and 4B are schematic diagrams showing regions of interest in an image of a welding operation in progress, according to an embodiment of the disclosure;

FIG. 5 is a schematic diagram of a neural network being used to identify regions of interest in an image of a welding operation in progress, according to an embodiment of the disclosure;

FIG. 6 is a schematic diagram of a neural network being used to process input data as part of a method of performing real-time inspection of a quality of a welding operation, according to an embodiment of the disclosure;

FIG. 7 is a flow diagram of a method of performing real-time inspection of a quality of a welding operation, according to an embodiment of the disclosure;

FIG. 8 shows a graphical user interface displaying in real-time various parameters of a welding operation, according to an embodiment of the disclosure;

FIG. 9 shows the graphical user interface of FIG. 8 displaying the identification of a source of deviation in the welding operation, according to an embodiment of the disclosure; and

FIG. 10 is a plot showing deviations in welding quality signals, according to an embodiment of the disclosure.

### DETAILED DESCRIPTION

The present disclosure seeks to provide methods, systems, and computer-readable media for performing inspection of a quality of a welding operation. While various embodiments of the disclosure are described below, the disclosure is not limited to these embodiments, and variations of these embodiments may well fall within the scope of the disclosure which is to be limited only by the appended claims.

Embodiments of the disclosure are directed at methods of monitoring welding process quality in real-time. For example, according to embodiments of the disclosure, quality indicators of the welding process may be monitored in real-time, and any deviations in the quality indicators may be automatically detected. The quality indicators may be based on incoming data. For example, with a video stream as input, the system may automatically distinguish particular regions of interest in the video stream, such as regions in images of the video stream showing melt spatter, arc, and base metal. The system may then determine one or more quality indicators or indices for the regions of interest. For example, in the case of video data, a quality indicator may be correlated with the density of the melt spatter or the size of the arc region. Based on the quality indicators determined for the regions of interest, the system may generate a welding quality signal that is continuously updated as the welding quality progresses. The welding quality signal may comprise, for example, a string of numbers. Each number may, for example, be associated with a particular quality indicator determined for a region of interest.

Advantageously, the welding quality signal may indicate in real-time whether the welding operation is progressing normally or whether the welding operation is progressing in such a manner that defects are more likely to be introduced into the resultant weld. Any deviation from normal progression may be detected based on changes to the welding quality signal. In addition, by comparing the welding quality signal to stored welding quality signals, any such deviations may be correlated to a particular source of welding process deviation, as described in further detail below.

According to embodiments of the disclosure, defects in a production line may be avoided by identifying a deviation, from one or more normal ranges, of one or more parameters representative of the progression of a welding operation. If a deviation from one or more normal ranges is identified, a notification may be outputted (for example via a display monitor) to a user (such as a welder in control of the welding operation) to inform the user that the welding is not progressing normally. Furthermore, the source of the deviation may also be communicated to the user. As a result, in response to detecting such a deterioration in the welding process, a closed-loop control system in charge of the welding operation may be prompted for real-time correction of the welding operation. The real-time correction may be based, for example, on the source of the deviation.

According to certain embodiments of the disclosure, by using a machine learning model to process data from the video stream as well as data from any other input streams, quality indicators may be efficiently extracted while eliminating the need for intensive recalibrations of the system depending on the welding application. Ultimately, by detecting process deviations in the welding operation, the system may enable the prediction of defects before they actually form, which may otherwise lead to costly downtime and reworks. As a result, the need for the continuous presence of a professional operator may be eliminated, thereby enhancing quality, safety, and reliability.

Generally, according to embodiments of the disclosure, methods, systems, and computer-readable media for performing automated and real-time quality inspection of a welding operation are described. According to certain embodiments, the system includes at least one camera that is attachable to a welding torch. The camera may generate a video stream during the welding operation. At regular intervals during the welding operation, images, or a subset of the video frames, may be used for analyzing a quality of the welding process.

During an initial development or training phase, the system is trained to correlate visual features (such as melt spatter or welding arc regions) in images obtained during training welding operations with known characteristics of the welding process. According to some embodiments, these visual features do not include portions of the finished weld, but rather are visual features that relate more directly to the welding operation in progress. These characteristics can then be used to interpret the quality of the welding process. In another step during the training phase, variations in the welding process characteristics may be correlated with sources of welding process deviation (e.g. sources leading to deviations from the normal progression of the welding operation).

During a deployment phase subsequent to the training phase, the system processes the visual features identified in real-time images taken during the welding operation. The correlations determined during the training phase may then be used to automatically identify welding process characteristics and evaluate the quality of the current welding operation. Detected deviations in the welding process may be correlated to one or more specific sources that may responsible for causing the deviations. In addition to determining a quality of a welding operation based on video data, the system also may incorporate data from other sensors such as electrical current and voltage meters for enhanced accuracy of welding quality evaluations.

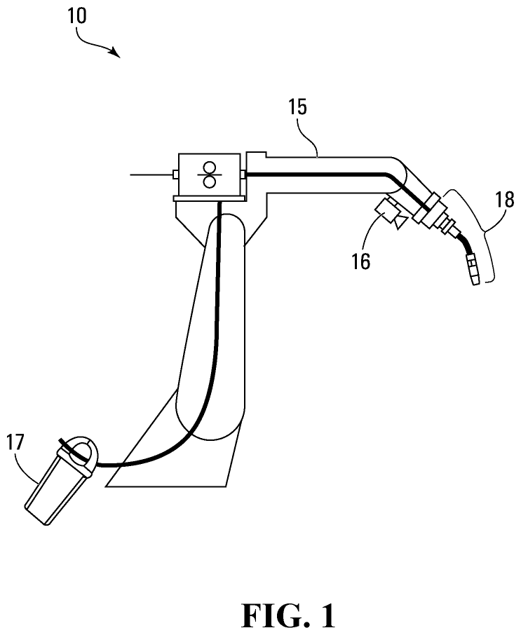

Turning to FIG. 1, according to an embodiment of the disclosure, there is shown a welding device 10 that may be used as part of the methods described herein for inspecting the quality of a welding operation. Welding device 10 includes a camera 16 and a clamp ammeter 17 attachable to a welding arm 15 of welding device 10. Welding device 10 may be part of an automated system, a semi-automated or collaborative system, or a manual welding setup. Camera 16 and clamp ammeter 17 are communicatively coupled to a welding operation monitoring system (not shown in FIG. 1 but described in further detail below) for automated and real-time quality inspection of a welding operation performed by welding device 10. Camera 16, clamp ammeter 17, and the welding operation monitoring system for automated and real-time quality inspection may be independent of any controlling hardware or software of welding device 10. Therefore, welding arm 15 may be any suitable arm, including a manual or automatic welding arm. Camera 16 and clamp ammeter 17 may be of any suitable kind for monitoring a welding operation, and therefore further details about their structure and operation are not described here. Other sensors that may be included with welding device 10 include one or more of, for example, a voltmeter, a gas flow meter, an acoustic sensor, a time-of-flight sensor, a vibration or motion sensor, and any other optical sensor that may detect light at any wavelength including, for example, ultraviolet (UV), infrared, or x-ray wavelengths.

Camera 16 is positioned to capture images of the welding operation without movement relative to the tip of a torch 18 of welding device 10, where torch 18 meets the surface being welded. According to some embodiments, one or more additional cameras may be positioned on or off torch 18 to capture images of different locations or at different distances relative to the tip of torch 18. Camera 16 captures digital video during the welding operation, and clamp ammeter 17 captures a continuous stream of electrical current data.

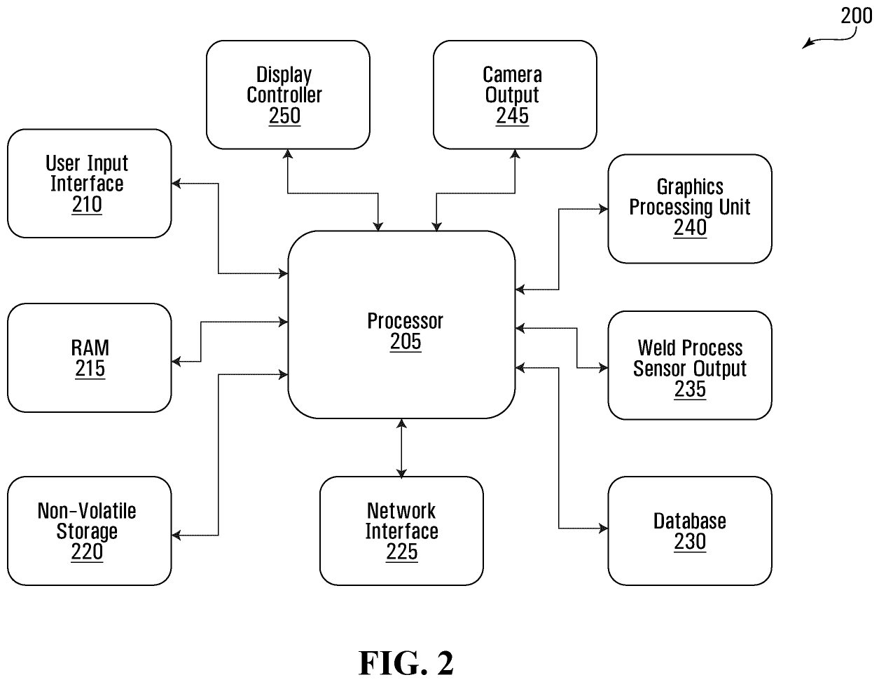

FIG. 2 is a schematic diagram showing a welding operation monitoring system 200 for inspecting the quality of a welding operation, according to an embodiment of the disclosure. Welding operation monitoring system 200 includes a processor 205 communicatively connected to a user input interface 210, random access memory (RAM) 215, non-volatile storage 220, a network interface 225, a database 230, outputs 235 of one or more weld process sensors (such as clamp ammeter 17), a graphics processing unit 240, output 245 of one or more cameras (such as camera 16), and a display controller 250.

As described above, processor 205 receives the video output from camera 16 and electrical current data from ammeter 17. Database 230 communicates with processor 205 and stores the received video and electrical current data. Processor 205 is communicatively coupled to and controls subsystems comprising user input interface 210, to which any one or more user input devices such as a keyboard, mouse, touch screen, and microphone may be connected; RAM 215, which stores computer program code that is executed at runtime by processor 205; non-volatile storage 220 (e.g. a solid state drive or magnetic spinning drive) which stores the computer program code loaded into RAM 215 for execution at runtime and other data; display controller 250 which may be communicatively coupled to and control a display (not shown); at least one graphical processing unit 240, used for parallelized processing as is not uncommon in vision processing tasks and related artificial intelligence operations; and network interface 225, which facilitates network communications with and via a network to which welding operation monitoring system 200 may be communicatively linked.

As will now be described in more detail, welding operation monitoring system 200, in conjunction with welding device 10, is used to identify characteristics or features that indicate the quality of the welding operation. These characteristics include but are not limited to visual features in images of the welding operation showing welding arc or spatter, audio captured during the welding operation using one or more audio sensors, a colour of a welding arc or laser produced during the welding operation, heat emitted or dissipated during the welding operation, an electrical current used for producing a welding arc or laser during the welding operation, a voltage used for producing a welding arc or laser during the welding operation, and any other characteristic that is not specific to a particular welding geometry or application.

Welding operation monitoring system 200 uses images, or a subset of video frames, acquired by camera 16, to identify characteristics therein for determining a quality of the welding operation. Regions of an image captured by camera 16 may represent visual features that are characteristics of the welding process and that may be correlated to welding process quality. Any such regions may be referred to herein as regions of interest (ROIs), and may include, for example, a region in an image showing welding arc and a region in an image showing melt spatter. According to some embodiments, the regions of interest do not include any portion of a weld that has been created as a result of the welding operation.

Whereas sensor data such as electrical current data may comprise a string of numbers that can be directly used to parameterize the quality of the welding process, an image of the welding process generally cannot be readily used for this purpose. Therefore, by determining a correlation between features in welding images and specific regions of interest, every image frame can be converted to a descriptive identifier, such as a number. These descriptive identifiers can then be more easily processed in processor 205 or stored in database 230.

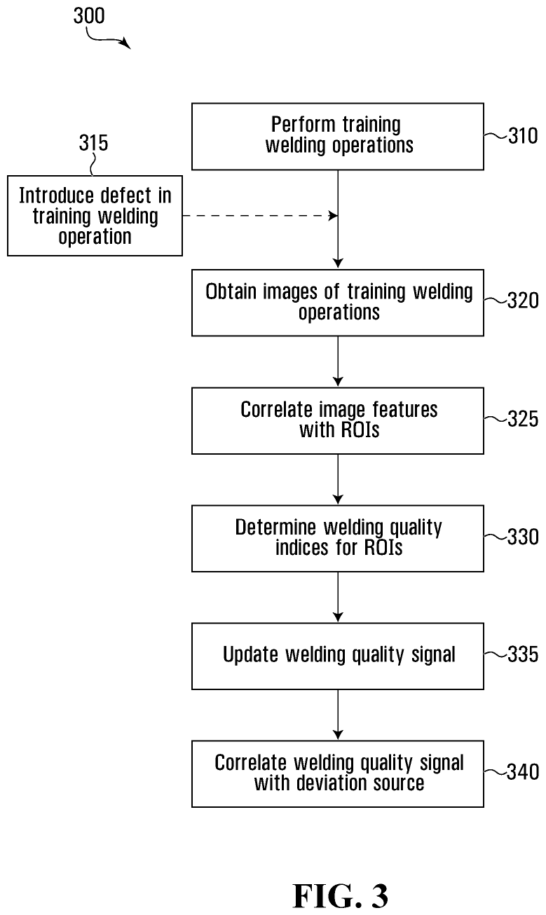

Turning to FIG. 3, there is now shown a flow diagram of the training phase of welding operation monitoring system 200. In the training phase, starting at block 310, a number of mock (“training”) welding operations are conducted using a welding setup having a camera to capture images of the training welding operation in progress, as well as other sensors. Such a welding setup may be similar or identical to the one shown in FIG. 1, for example. These training welding operations may include regular welding tests conducted with no intentional variation of the welding parameters.

The training welding operations may also include planned tests wherein one or more welding parameters are set or varied during operation in accordance with an experimental plan. The welding parameters may include, but are not limited to, electrical current, voltage, protective gas flow, the speed of movement of the welding torch, and the temperature of the weld surface. As indicated by block 315, training welding operations may also include tests wherein sources of deviation in the welding process are deliberately introduced. These sources of deviation may include, for example, the presence of moisture or oil droplets on the weld surface or on welding consumables, and the presence of rust or any other solid contaminant on the weld surface.

During the training welding operations, at block 320, images are captured by the camera, and other measurements may be taken by other sensors included in the welding setup to collect other data relating to the welding operation. Such other, non-video data may be referred to herein as “weld process data”. For example, referring to the example configurations in FIGS. 1 and 2, the data collected by camera 16 and electrical current sensor 17 are transmitted to processor 205 during the training welding operations. Other data relating to welding parameters and sources of deviation in the welding operations, if any, are also transmitted to processor 205 together with the video data from camera 16 and electrical current data from electrical current sensor 17, concurrent with or delayed relative to the transmission of the video data. This data may include numeral representations of the welding parameters and, for example, an array of distinctive digits with each digit associated with a specific source of deviation. Accordingly, the presence of a particular digit in the array may denote the presence of an associated source of deviation during the training welding operation. The data can be entered into processor 205 manually by a person observing the welding process, or may be generated and transmitted by the control system of welding arm 15. Processor 205 communicates the data to database 230 for storage.

At block 325, features in the images are correlated with specific ROIs. Examples of ROIs are regions showing welding arc and regions showing melt spatter. Depending on the welding application, other ROIs may be considered, including, but not limited to, regions associated with a melt pool of a weld or a weld seam of a weld. In the following, an example process of correlating features in a given welding image with a specific ROI is described.

A digital image received from the camera, such as camera 16, comprises a layout of pixels, each pixel positioned at specific coordinates. Each pixel of an image has at least one value associated with it, and sometimes more than one value depending on the type of the image. The value associated with each pixel is associated with the colour of the pixel. The values for the pixels of a particular image are included in a matrix for that image, referred to herein as an image matrix.

One method of correlating areas in welding images with specific ROIs uses a matrix with the same size and coordinate system as the original image for the ROI in question. A difference between ROI matrices and the original image matrix is that, in ROI matrices, each pixel is set to either 1 or 0. In other words, ROI matrices indicate layouts of 0 s and 1 s denoting a specific ROI. A value of 1 for a specific pixel in an ROI matrix indicates that the pixel with the same coordinates in the original image corresponds to that ROI. For example, in the matrix relating to the welding arc region, a value of 1 for a pixel with coordinates (i,j) means that the pixel (i,j) in the original image corresponds to the welding arc region. It is possible that all pixels in an ROI matrix are equal to 0, thereby indicating that the particular ROI in question does not exist in the original image. At block 325, the ROI matrices may be predetermined. For example, a user may determine a specific region in a welding image that corresponds to an ROI. The user may then assign a value of 1 to each pixel in the related ROI matrix.

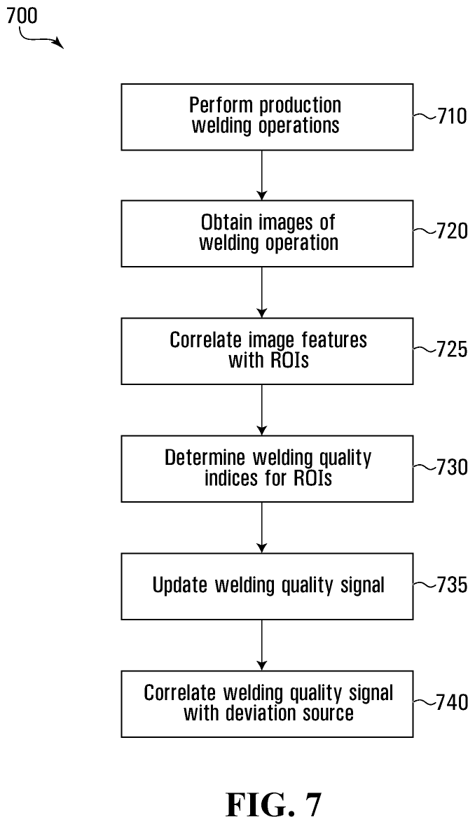

The image matrices corresponding to the original welding images may be fit to a mathematical function such as an nth-order polynomial. During the training phase, the mathematical parameters of this function are set so as to generate an approximation of the predetermined ROI matrices. This process may be repeated for each different ROI, with separate mathematical functions for each ROI. During a deployment phase (subsequent to the training phase), the mathematical function is applied to welding images to automatically approximate ROI matrices. The mathematical function may be similar to a “Canny algorithm” that is used for edge detection. A Canny algorithm may convert an image to other matrices or layouts corresponding to specific features in the original image. The mathematical function can be stored in database 230 for access by processor 205 during a later deployment phase (see FIG. 7).

According to some embodiments, any of the following mathematical functions or operations may be used to correlate features in the images of the training welding operations to ROIs: machine learning including the use of artificial neural networks, Gaussian process regression, a logistical model tree, a random forest, a fuzzy classifier, a decision tree, hierarchical clustering, k-means, fuzzy clustering, deep Boltzmann machine learning, a deep convolutional neural network, a deep recurrent neural network, and any combination thereof.

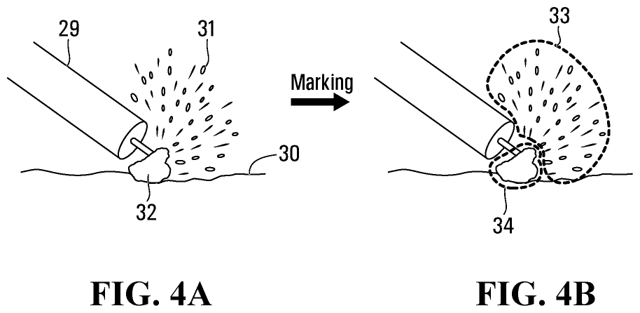

FIG. 4A shows a schematic of arc welding deposition on a weld surface 30, using a welding torch 29. The arc 32 is the essence of an arc welding process as it generates the heat required to melt material. Moreover, arc welding processes often generate melt spatter 31, as seen in FIG. 4B. In this example, welding arc 32 and melt spatter 31 are both characteristics that may be correlated to the quality of the weld. FIG. 4B is an illustrative example of identifying welding arc 32 and melt spatter 31 in a welding image under as regions of interest 34 and 33, respectively.

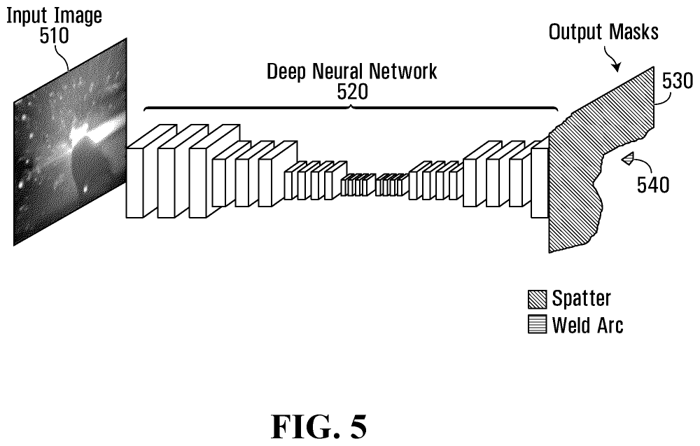

FIG. 5 shows an example of how a neural network (such as a CNN) may be used to identify ROIs within a raw image file. An input image 510 is input to a trained CNN 520 which may identify particular ROIs as an output. In the example of FIG. 5, a melt spatter region 530 and a weld arc region 640 are both identified. ROIs may be identified using other methods such as classic computer vision and edge detection. The process of identifying ROIs may also be achieved using a combination of edge detection and image filtering based on pixel value, since arc and melt spatter regions are often the brightest regions of an image.

As explained above, ROI matrices, such as the matrices for melt spatter regions and welding arc regions, comprise layouts with the same size and coordinate system as the original image matrix. At block 330, a welding quality index or indicator is determined for the ROI matrices. For example, the fraction of pixels in the ROI matrix with the value of 1 (corresponding to the pixels relating to that ROI in the original image) is determined for each ROI. By determining this fraction for each ROI, the visual observation of the ROI in the welding image may be converted to a number. For example, according to some embodiments, the greater the fraction of pixels in the melt spatter ROI matrix that correspond to the pixels relating to this ROI in the original image, the lower the quality of the welding process.

The process of determining the fraction of pixels in the ROI matrix corresponding to the pixels relating to that ROI in the original image can be accomplished by processor 205, and the resulting number can be stored in database 230. This process of determining the fraction of pixels in the ROI matrix that correspond to the pixels relating to that ROI in the original image is an exemplary method of converting ROI matrices to descriptive numbers. An ROI matrix can also be used to determine other parameters including but not limited to the density of a specific feature (for example the density of spattering across a particular region or regions of the image) as well as coordinates of a specific feature (such as the centroid of a weld arc region).

At block 335, a welding quality signal is updated. The welding quality signal may be indicative of the quality of the welding operation. According to one embodiment, the welding quality indices computed at block 330 are added to a pre-initialized string of numbers (“number strings”) associated with the ROI. For example, one number string may be pre-initialized for each ROI. In particular, each number string is initialized at block 335 by processor 225 for every training welding operation, for example, in response to the first frame of the welding video being received at processor 225. As the welding process progresses and video from the training welding operation is collected and processed by processor 225, new numbers are added to the end of the number strings for each new frame of video data that is processed. Therefore, each number string contains information relating to a specific ROI and its variation throughout the welding process.

Similarly, data from other sensors, such as ammeter 17, may be included in a number string. The number string associated with ammeter 17 therefore includes the electrical current data throughout the welding process.

According to some embodiments, a number string relating to an ROI may be combined with a number string relating to non-video data (such as electrical current data), in which case the number strings may be combined into a higher-dimensional array of numbers.

Accordingly, raw welding image data is converted into quantifiable numbers and, consequently, converting a video of the welding process into a number string can be used to parameterize the quality of the welding process in real-time (or after the welding process has terminated, by processing stored video of the welding operation).

At block 340, the welding quality signal (e.g. the updated number string) may be correlated to one or more sources of welding process deviation. In particular, data corresponding to one or more sources of welding process deviation was provided to processor 205 at blocks 315 and 320. Therefore, at block 340, data is collected during training welding operations in which the deviation source may have been artificially introduced (at block 315). Examples of sources of welding process deviation include, but are not limited to, the presence of moisture or oil droplets on the weld surface, electrical current or voltage interruptions, the presence of dust or other solid particles on weld surface, and interruptions in a protective gas pressure.

An example method of correlating the welding quality signal to a deviation source will now be described. Welding quality signals may be fit to another mathematical function such as an nth-order polynomial. During the training phase, the parameters of the mathematical function are set so as to approximate the source of deviation artificially introduced at block 315. According to one example representation of the source of deviation as an output of this mathematical function, an identifier such as an arbitrary digit may be assigned to each deviation source. For instance, the number 1 may be assigned to the presence of moisture on the weld surface, the number 2 may be assigned to the present of dust on the weld surface, the number 3 may be assigned to an interruption in a protective gas pressure, etc. Another possible form of output for this mathematical function is an array of probabilities, with each element of the array associated with a probability of a particular deviation source. For example, a probability of 60% for moisture on the weld surface indicates that this source can be associated with the input string of numbers with a probability of 60%.

During a deployment phase (after training is complete), the mathematical function is applied to the welding quality signal (e.g. an input number string) to automatically approximate the source of welding process deviation to the welding quality signal. The input to this mathematical function may include, for example, an individual number string or a subset of the number string, combined number strings from all ROIs, a subset of the combined number strings from all ROIs, or ROI-related number strings combined with other numerical signals such as the data from electrical sensors, provided that the type of input data used during the training phase is consistent with the type of input data used during the deployment phase.

An identifier such as the digit 0 can be assigned to be the output if the input string, or strings, of numbers does not correspond to any known source of deviation. At least one training welding operation and its related ROI number strings must be available to processor 205 for any source of deviation to be fit to the mathematical function at block 340. The mathematical function used at block 340 can be stored in database 230, for later use by processor 205. According to some embodiments, any of the following mathematical functions or operations may be used to correlate the welding quality signal to a deviation source: machine learning including the use of artificial neural networks, Gaussian process regression, a logistical model tree, a random forest, a fuzzy classifier, a decision tree, hierarchical clustering, k-means, fuzzy clustering, deep Boltzmann machine learning, a deep convolutional neural network, a deep recurrent neural network, and any combination thereof.

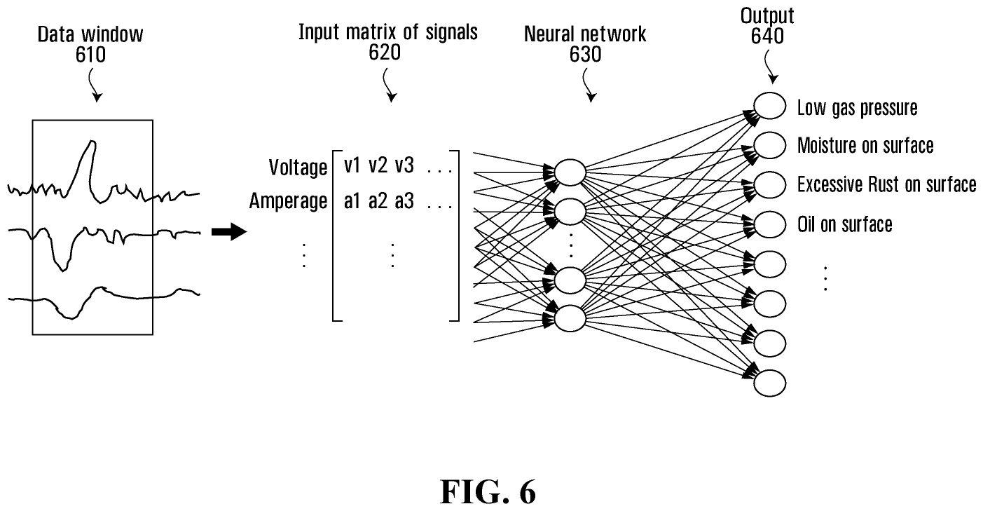

In FIG. 6, there is shown an example of a trained neural network being used to correlate a welding quality signal to a welding deviation source. Raw data 610, which includes both image data (obtained by camera 16) and electrical current data (obtained by electrical current sensor 17), is processed into corresponding ROI matrices (not shown). ROI matrices 620 are then processed as described above to determine welding quality indices and thereby generate a welding quality signal 620. Welding quality signal 620 is then processed by a trained neural network 630 (such as a convolutional neural network) to thereby generate possible welding deviation sources 640 as an output. For example, a probability may be associated with each welding deviation sources 640 output from the neural network.

Turning to FIG. 7, there is now shown a flow diagram of a deployment phase of welding operation monitoring system 200, after training of welding operation monitoring system 200 as per FIG. 3.

At block 710, production welding operations are conducted using a welding operation monitoring system, such as welding operation monitoring system 200. At block 720, data collected from camera 16 and electrical current sensor 17 (if included) is transmitted to processor 205. The processor 205 stores the data in database 230.

At block 725, the mathematical function with mathematical parameters fit at block 325 of the training phase is recalled by processor 205 from database 230 to process the welding images, or a subset of frames of video, in order to generate ROI matrices. ROI matrices generated at block 725 have the same size and coordinate system as the original image, with the difference that, in the ROI matrices, each pixel is set to either 1 or 0. As explained above, ROI matrices provide layouts of 0 s and 1 s denoting a specific ROI. The value of 1 for a pixel in an ROI matrix indicates that the pixel at the same coordinates in the original image corresponds to that particular ROI.

At block 730, fraction of pixels in the ROI matrix corresponding to the pixels relating to that ROI in the original image is determined. The determination of the fraction converts the visual observation of the ROI in the welding image to a welding quality index, which may be for example a number.

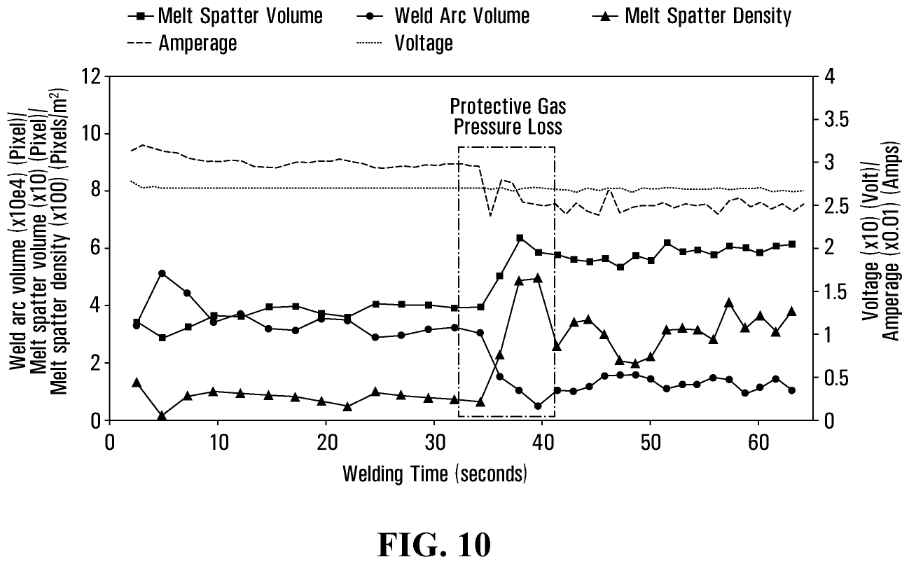

At block 735, one or more welding quality signals indicative of a quality of the welding operation are updated. In particular, the welding quality indices determined at 730 are added to a pre-initialized number string associated with the ROIs, with one string for each ROI. As described above, these strings are initialized by processor 205, for every welding operation, in response, for example, to the first frame of the welding video being received at processor 205. Each welding quality signal may correspond to a different parameter of the welding operation that is being monitored. For example, one welding quality signal may correspond to weld arc volume, another welding quality signal may correspond to melt spatter volume, another welding quality signal may correspond to melt spatter density, etc. (see FIG. 10 for an example of the progression of multiple welding quality signals).

Blocks 720 through 735 may be performed repeatedly throughout the welding operation such that, for each ROI, processor 205 adds a number to the number string with every welding image processed as a single frame from the video from camera 16. The continuation of the video feed and repetition of blocks 720 through 735 converts the video into a number string. Therefore, raw images collected from the video from camera 16 are converted to a numerical format that can be used to parameterize the quality of the welding process.

At block 740, the welding quality signal may be used to determine a welding process deviation source. In particular, the welding quality signal may be compared to each of one or more stored welding quality signals. As described above, each stored welding quality signal may be associated with a respective source of a deviation of the stored welding quality signal from one or more normal welding quality signals associated with one or more welding operations that progressed normally. Based on the comparison of the welding quality signal to each of the stored welding quality signals, a source of the deviation of the welding quality signal from the one or more normal welding quality signals may be identified.

In particular, this may be achieved by using correlations between welding process deviations sources and number strings as determined at block 340 during the training phase. In particular, processor 205 may apply the mathematical function, used at block 340, to the number string updated at block 735 to compute the digit associated with a deviation source. This process may use the entire length of the number string, an arbitrary subset of the number string, or any combination of the number string that can also incorporate data from other sensors such as clamp ammeter 17. Depending on the fitting process used at block 340, the mathematical function may generate a value, such as 0, denoting normal progression of the welding process, i.e. no source of welding process deviation has been detected.

According to some embodiments, the number string generated at block 735 may be thresholded based on one or more experimentally or analytically determined thresholds. A notification may be generated if the number string exceeds the threshold. For example, processor 205 may generate a warning notification in the event that one or more number strings associated with the melt spatter ROI exceed 60% of the image matrix. According to still further embodiments, the number strings generated at block 735 may be used to generate commands in a closed-loop control system with or without incorporating a threshold value. For example, in the case where a threshold is used, processor 205 may generate a command to reduce electrical current in the event that the number string associated with the melt spatter ROI exceeds a certain threshold found experimentally or analytically.

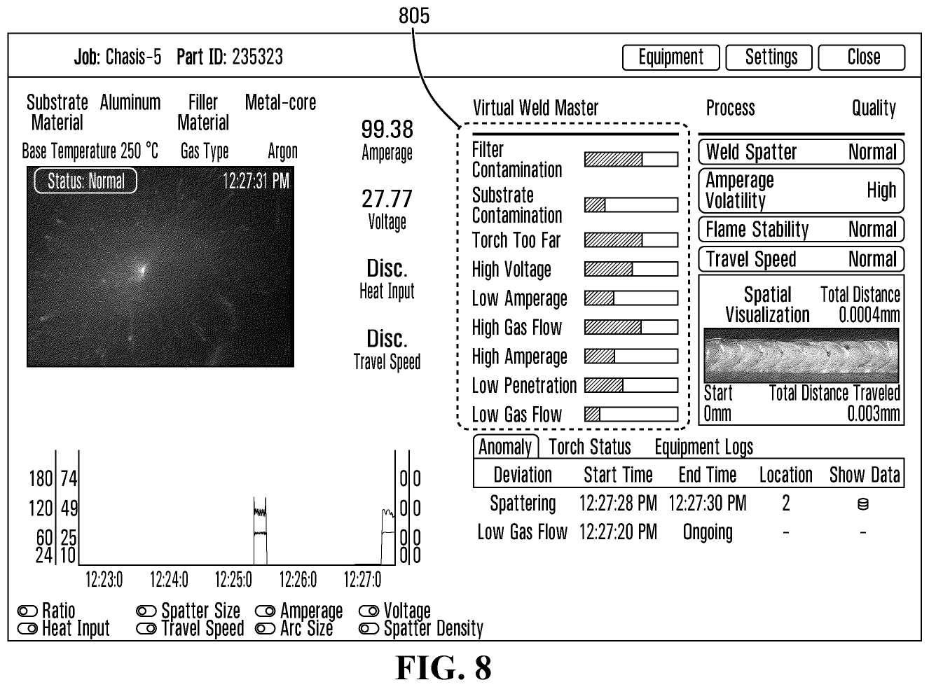

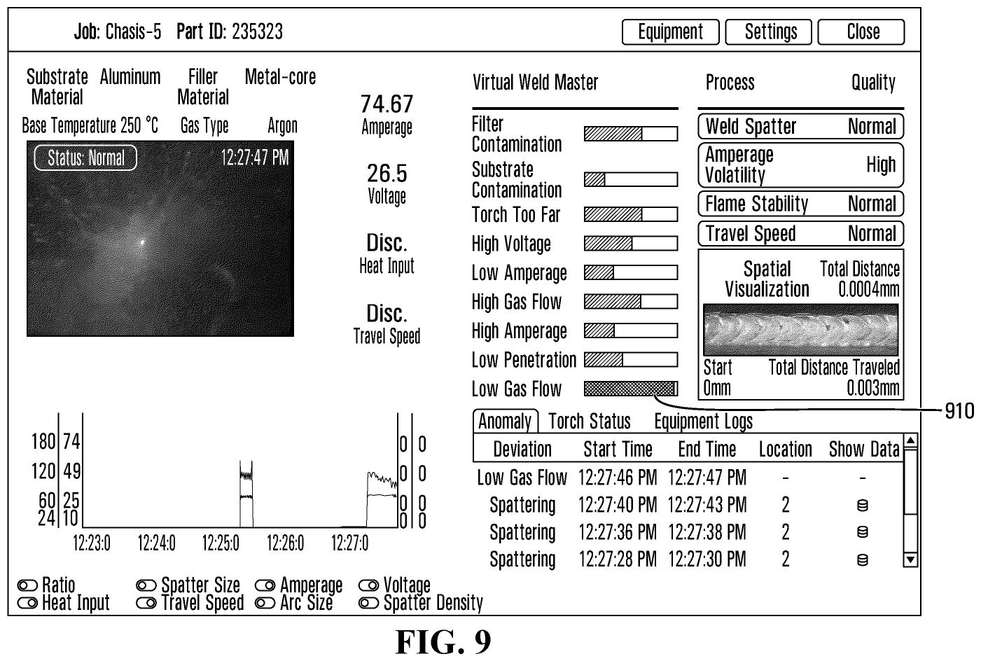

FIGS. 8 and 9 show a graphical user interface displaying an output of welding operation monitoring system 200. Various welding deviation sources are indicated at 805. As can be seen in FIG. 9, the welding quality signal has been correlated to a particular welding deviation source, namely low gas flow 910. Thus, a user may be notified that the welding operation is not progressing as normal as a low gas flow has been detected and as a result the welding operation may be about to deteriorate.

Turning to FIG. 10, there is shown an example output of welding operation monitoring system 200. In particular, there is shown a plot of multiple welding quality signals relating in particular to: weld arc volume, melt spatter volume, melt spatter density, amperage, and voltage, as a function of time that has elapsed during the welding operation. As can be seen, at about 33 seconds, each of the welding quality signals undergoes a significant deviation from a previous steady-state. Welding operation monitoring system 200 may detect this process deviation and, using for example the method described above, may correlate it to a pressure loss of a protective gas (this being the source of the deviation).

Embodiments of the disclosure may enable automated deviation source analysis allowing production lines to resolve welding process issues with minimal downtime while saving significant resources. The welding operation monitoring system described herein may be integrated into a larger automated or semi-automated welding system and corresponding closed-loop control system. This may enable the welding operation monitoring system to generate commands based on predictions of welding deviations sources. For example, in response to detecting a welding deviation source, one or more welding parameters may be automatically adjusted to avoid further progression of the welding process with the detected welding deviation source which could otherwise lead to a high possibility of defect formation.

According to some embodiments, the welding operation monitoring system described herein may be used for laser welding as well as arc welding, or any other suitable form of welding or similar operation. For example, the welding operation monitoring system may be used in a wire arc additive manufacturing (WAAM) process, a metal inert gas (MIG) welding process, a tungsten inert gas (TIG) welding process, a stick-welding process, or a gas metal arc welding (GMAW) process.

The embodiments have been described above with reference to flowcharts and block diagrams of methods, apparatuses, systems, and computer program products. In this regard, the flowcharts and block diagrams in the figures illustrate the architecture, functionality, and operation of possible implementations of various embodiments. For instance, each block of the flowcharts and block diagrams may represent a module, segment, or portion of code, which comprises one or more executable instructions for implementing the specified logical function(s). In some alternative embodiments, the functions noted in that block may occur out of the order noted in those figures. For example, two blocks shown in succession may, in some embodiments, be executed substantially concurrently, or the blocks may sometimes be executed in the reverse order, depending upon the functionality involved. Some specific examples of the foregoing have been noted above but those noted examples are not necessarily the only examples. Each block of the block diagrams and flowcharts, and combinations of those blocks, may be implemented by special purpose hardware-based systems that perform the specified functions or acts, or combinations of special purpose hardware and computer instructions.

Each block of the flowcharts and block diagrams and combinations thereof can be implemented by computer program instructions. These computer program instructions may be provided to a processor of a general-purpose computer, special-purpose computer, or other programmable data processing apparatus to produce a machine, such that the instructions, which execute via the processor of the computer or other programmable data-processing apparatus, create means for implementing the functions or acts specified in the blocks of the flowcharts and block diagrams.

These computer program instructions may also be stored in a computer-readable medium that can direct a computer, other programmable data-processing apparatus, or other devices to function in a particular manner, such that the instructions stored in the computer-readable medium produce an article of manufacture including instructions that implement the function or act specified in the blocks of the flowcharts and block diagrams. The computer program instructions may also be loaded onto a computer, other programmable data-processing apparatus, or other devices to cause a series of operational steps to be performed on the computer, other programmable apparatus or other devices to produce a computer-implemented process such that the instructions that execute on the computer or other programmable apparatus provide processes for implementing the functions or acts specified in the blocks of the flowcharts and block diagrams.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

While the disclosure has been described in connection with specific embodiments, it is to be understood that the disclosure is not limited to these embodiments, and that alterations, modifications, and variations of these embodiments may be carried out by the skilled person without departing from the scope of the disclosure. It is furthermore contemplated that any part of any aspect or embodiment discussed in this specification can be implemented or combined with any part of any other aspect or embodiment discussed in this specification.

1. A computer-implemented method of monitoring a quality of a welding operation, the method comprising:
obtaining video of the welding operation in progress;
processing the video to identify regions of interest in the video, each region of interest corresponding to a portion of an image in the video;
for each region of interest, determining a quality index by processing the portion of the image corresponding to the region of interest;
based on the quality indices determined for the regions of interest, generating one or more welding quality signals indicative of the quality of the welding operation;
determining, based on the one or more welding quality signals, that the welding operation is not progressing normally;
in response to determining that the welding operation is not progressing normally, comparing the one or more welding quality signals to one or more stored welding quality signals, wherein each stored welding quality signal is associated with a respective source of a deviation of the stored welding quality signal from one or more normal welding quality signals associated with one or more welding operations that progressed normally; and
identifying, based on the comparison, a source of the deviation of the one or more welding quality signals from the one or more normal welding quality signals.

2. The method of claim 1, further comprising, based on the identification of the source of the deviation of the one or more welding quality signals, adjusting one or more parameters of the welding operation so as to adjust a progression of the welding operation.

3. The method of claim 1, wherein obtaining the video comprises capturing, using one or more cameras, images of the welding operation in progress.

4. The method of claim 1, wherein processing the video to identify the regions of interest comprises:
extracting one or more features from images in the video;
comparing the extracted one or more features to one or more stored features, wherein the one or more stored features are extracted from images obtained from one or more other welding operations and comprising the regions of interest; and
identifying, based on the comparison, the regions of interest in the video of the welding operation.

5. The method of claim 1, further comprising, during a training phase prior to the welding operation:
obtaining video of each of multiple training welding operations;
for each training welding operation, processing the video of the training welding operation to identify training regions of interest in the video, each training region of interest corresponding to a portion of an image in the video of the training welding operation; and
for each training region of interest, determining a quality index based on a quality of the training welding operation associated with the training region of interest.

6. The method of claim 5, wherein determining the quality index comprises:
comparing the processed portion of the image corresponding to the region of interest to one or more processed portions of the images corresponding to the training regions of interest; and
based on the comparison and based on one or more quality indices determined for the training regions of interest, determining the quality index for the region of interest.

7. The method of claim 5, wherein, during at least one of the training welding operations, a process deviation is introduced into the at least one of the training welding operations.

8. The method of claim 7, wherein the process deviation comprises one or more of: a current or voltage interruption; a wire feed interruption; a protective gas flow interruption; burn-through; oil, grease, moisture, dust, oxidation, or rust on the surface of the weld; and a welding arc or laser interruption.

9. The method of claim 1, wherein processing the video to identify the regions of interest comprises:
inputting the video to a trained neural network; and
identifying the regions of interest using the trained neural network.

10. The method of claim 1, wherein determining the quality index comprises:
processing the portion of the image corresponding to the region of interest;
comparing the processed portion of the image corresponding to the region of interest to a stored processed portion of an image, wherein the stored processed portion of the image corresponds to a region of interest identified in the video of one or more other welding operations; and
based on the comparison, determining the quality index for the region of interest.

11. The method of claim 10, wherein:
processing the portion of the image corresponding to the region of interest comprises converting the portion of the image corresponding to the region of interest to a first matrix representing the region of interest; and
comparing the processed portion of the image to the stored processed portion of the image comprises comparing the first matrix to a second matrix representing the region of interest corresponding to the stored processed portion of the image.

12. The method of claim 11, wherein determining the quality index comprises:
identifying one or more similarities between the first matrix and the second matrix; and
determining the quality index based on the one or more similarities.

13. The method of claim 1, wherein the regions of interest comprise one or more of:
a melt spatter region corresponding to a portion in each of one or more images in the video, wherein the portion shows melt spatter occurring during the welding operation;
a welding arc or laser region corresponding to a portion in each of one or more images in the video, wherein the portion shows a welding arc or laser produced during the welding operation;
a melt pool region corresponding to a portion in each of one or more images in the video, wherein the portion shows a melt pool formed during the welding operation; and
a weld seam region corresponding to a portion in each of one or more images in the video, wherein the portion shows a weld seam formed during the welding operation.

14. The method of claim 13, wherein the regions of interest consist of one or more of:
the melt spatter region;
the welding arc or laser region;
the melt pool region; and
the weld seam region.

15. The method of claim 1, further comprising, during the welding operation:
obtaining welding process data associated with the welding operation; and
determining one or more process quality indices for the welding process data, wherein generating the one or more welding quality signals is further based on the one or more process quality indices.

16. The method of claim 15, wherein determining the one or more process quality indices comprises:
comparing the welding process data to stored welding process data, wherein the stored welding process data is associated with one or more other welding operations; and
based on the comparison, determining the one or more process quality indices.

17. The method of claim 15, further comprising, during a training phase prior to the welding operation:
obtaining sets of welding process data associated with multiple training welding operations; and
for each set of welding process data associated with a given one of the training welding operations, determining a process quality index based on a quality of the training welding operation associated with the welding process data.

18. The method of claim 17, wherein determining the one or more process quality indices comprises:
comparing the welding process data associated with the welding operation to the welding process data associated with the training welding operations; and
based on the comparison and based on the one or more process quality indices determined for the welding process data associated with the training welding operations, determining the one or more welding process quality indices for the welding process data associated with the welding operation.

19. The method of claim 15, wherein the welding process data comprises data relating to one or more of:
audio captured during the welding operation using one or more audio sensors;
a colour of a welding arc or laser produced during the welding operation;
heat emitted or dissipated during the welding operation;
a current used for producing a welding arc or laser during the welding operation; and
a voltage used for producing a welding arc or laser during the welding operation.

20. The method of claim 1, wherein determining that the welding operation is not progressing normally comprises:
comparing the one or more welding quality signals to one or more thresholds; and
determining, based on the comparison, that the welding operation is not progressing normally.

21. The method of claim 1, further comprising, during a training phase prior to the welding operation, generating the one or more stored welding quality signals by:
obtaining video of each of one or more training welding operations, wherein at least one of the one or more training welding operations did not progress normally;
for each training welding operation, processing the video of the training welding operation to identify training regions of interest in the video, each training region of interest corresponding to a portion of an image in the video of the training welding operation;
for each training region of interest, determining a quality index based on a quality of the training welding operation associated with the training region of interest;
based on the quality indices determined for the training regions of interest, generating, for each of the training welding operations, one or more welding quality signals; and
storing the generated one or more welding quality signals to thereby form the one or more stored welding quality signals.

22. The method of claim 1, wherein generating the one or more welding quality signals comprises generating one or more strings of numbers, wherein each number is based on the quality index determined for one of the regions of interest.

23. The method of claim 15, wherein generating the one or more welding quality signals comprises generating one or more strings of numbers, wherein each number is based on one of the process quality indices determined for the welding process data.

24. A system for monitoring a quality of a welding operation, comprising:
a welding device for performing a welding operation;
one or more cameras positioned so as to capture video of the welding operation when in progress; and
one or more processors communicative with the one or more cameras and configured, during the welding operation, to:
obtain, from the one or more cameras, video of the welding operation in progress;
process the video to identify regions of interest in the video, each region of interest corresponding to a portion of an image in the video;
for each region of interest, determine a quality index by processing the portion of the image corresponding to the region of interest;
based on the quality indices determined for the regions of interest, generate one or more welding quality signals indicative of the quality of the welding operation;
determine, based on the one or more welding quality signals, that the welding operation is not progressing normally;
in response to determining that the welding operation is not progressing normally, compare the one or more welding quality signals to one or more stored welding quality signals, wherein each stored welding quality signal is associated with a respective source of a deviation of the stored welding quality signal from one or more normal welding quality signals associated with one or more welding operations that progressed normally; and
identify, based on the comparison, a source of the deviation of the one or more welding quality signals from the one or more normal welding quality signals.

25. A non-transitory computer-readable medium having stored thereon computer program code configured, when executed by one or more processors, to perform a method comprising:
obtaining video of a welding operation in progress;
processing the video to identify regions of interest in the video, each region of interest corresponding to a portion of an image in the video;
for each region of interest, determining a quality index by processing the portion of the image corresponding to the region of interest;
based on the quality indices determined for the regions of interest, generating one or more welding quality signals indicative of the quality of the welding operation;
determining, based on the one or more welding quality signals, that the welding operation is not progressing normally;
in response to determining that the welding operation is not progressing normally, comparing the one or more welding quality signals to one or more stored welding quality signals, wherein each stored welding quality signal is associated with a respective source of a deviation of the stored welding quality signal from one or more normal welding quality signals associated with one or more welding operations that progressed normally; and
identifying, based on the comparison, a source of the deviation of the one or more welding quality signals from the one or more normal welding quality signals.

26. A computer-implemented method of monitoring a quality of a welding operation creating a weld, the method comprising:
obtaining video of the welding operation in progress;
processing the video to identify regions of interest in the video, each region of interest corresponding to a portion of an image in the video, wherein the portion of the image does not include the weld;
for each region of interest, determining a quality index by processing the portion of the image corresponding to the region of interest;
based on the quality indices determined for the regions of interest, generating one or more welding quality signals indicative of the quality of the welding operation.
